(19) United States
(12) Patent Application Publication
(10) Pub. No.: US 2026/0046861 A1
(43) Pub. Date: Feb. 12, 2026

(54) DYNAMIC START TIMES FOR PERIODIC COMMUNICATIONS OF AN AUDIO DEVICE

(71) Applicant: QUALCOMM Incorporated, San Diego, CA (US)

(72) Inventors: Ahmed Ragab ELSHERIF, San Jose, CA (US); Rong HE, San Diego, CA (US); Sriman MIRYALA, Hyderabad (IN)

(21) Appl. No.: 19/100,301

(22) PCT Filed: Mar. 14, 2023
(86) PCT No.: PCT/US2023/064320

§ 371 Date: Jan. 31, 2025

(30) Foreign Application Priority Data
Oct. 5, 2022 (IN) 202221057109

(51) Int. Cl. H04W 72/12

(52) U.S. Cl. CPC H04W 72/12

(57) ABSTRACT

Various aspects of the present disclosure generally relate to wireless communication. In some aspects, a wireless communication device (WCD) may communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length. The WCD may transmit, to the second audio device and based at least in part on detection of a change in the first duration, an indication of a second start time, that is different from the first start time, associated with the second audio device. Numerous other aspects are described.

### CROSS-REFERENCE TO RELATED APPLICATION

This patent application claims priority to Indian Patent Application No. 202221057109, filed on 5 Oct. 2022, entitled “DYNAMIC START TIMES FOR PERIODIC COMMUNICATIONS OF AN AUDIO DEVICE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for dynamic start times for periodic communications of an audio device.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (WPAN), which may include a Bluetooth connection, may provide for short range wireless connections between two or more paired wireless devices. For example, wireless devices such as cellular phones may utilize WPAN communications to exchange information such as audio signals with wireless headsets.

### SUMMARY

Some aspects described herein relate to a method of wireless communication performed by a wireless communication device (WCD). The method may include communicating, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length. The method may include transmitting, to the second audio device and based at least in part on detection of a change in the first duration, an indication of a second start time, that is different from the first start time, associated with the second audio device.

Some aspects described herein relate to a method of wireless communication performed by a second audio device. The method may include communicating, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length. The method may include receiving, from the WCD and based at least in part on detection of a change in the first duration, an indication of a second start time, that is different from the first start time, associated with the second audio device.

Some aspects described herein relate to a WCD for wireless communication. The WCD may include a memory and one or more processors coupled to the memory. The one or more processors may be configured to communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length. The one or more processors may be configured to transmit, to the second audio device and based at least in part on detection of a change in the first duration, an indication of a second start time, that is different from the first start time, associated with the second audio device.

Some aspects described herein relate to a second audio device for wireless communication. The second audio device may include a memory and one or more processors coupled to the memory. The one or more processors may be configured to communicate, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length. The one or more processors may be configured to receive, from the WCD and based at least in part on detection of a change in the first duration, an indication of a second start time, that is different from the first start time, associated with the second audio device.

Some aspects described herein relate to a non-transitory computer-readable medium that stores a set of instructions for wireless communication by a WCD. The set of instructions, when executed by one or more processors of the WCD, may cause the WCD to communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length. The set of instructions, when executed by one or more processors of the WCD, may cause the WCD to transmit, to the second audio device and based at least in part on detection of a change in the first duration, an indication of a second start time, that is different from the first start time, associated with the second audio device.

Some aspects described herein relate to a non-transitory computer-readable medium that stores a set of instructions for wireless communication by a second audio device. The set of instructions, when executed by one or more processors of the second audio device, may cause the second audio device to communicate, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length. The set of instructions, when executed by one or more processors of the second audio device, may cause the second audio device to receive, from the WCD and based at least in part on detection of a change in the first duration, an indication of a second start time, that is different from the first start time, associated with the second audio device.

Some aspects described herein relate to an apparatus for wireless communication. The apparatus may include means for communicating, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length. The apparatus may include means for transmitting, to the second audio device and based at least in part on detection of a change in the first duration, an indication of a second start time, that is different from the first start time, associated with the second audio device.

Some aspects described herein relate to an apparatus for wireless communication. The apparatus may include means for communicating, during a time period and via a second wireless connection, with a WCD associated with a first wireless connection with a first audio device, periodic communications between the WCD and the first audio device having a first start time that is fixed and a first duration that is variable in length and periodic communications between the WCD and the apparatus having a first start time and a second duration that is variable in length. The apparatus may include means for receiving, from the WCD and based at least in part on detection of a change in the first duration, an indication of a second start time, that is different from the first start time, associated with the second audio device.

Aspects generally include a method, apparatus, system, computer program product, non-transitory computer-readable medium, user equipment, base station, network entity, network node, WCD, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates a wireless communications system configured in accordance with the present disclosure.

FIG. 2 illustrates an example of a wireless communications system that supports low-latency parameter updates for extended personal area networks, in accordance with one or more aspects of the present disclosure.

FIG. 3 is a diagram of an example associated with target wake time (TWT) service interval (SI) communications involving a first audio device and a second audio device using time domain multiplexing, in accordance with the present disclosure.

FIG. 4 is a diagram of an example associated with dynamic start times for periodic communications of an audio device, in accordance with the present disclosure.

FIG. 5 is a diagram of an example associated with dynamic start times for periodic communications of an audio device, in accordance with the present disclosure.

FIG. 6 is a diagram illustrating an example process performed, for example, by a wireless communication device (WCD), in accordance with the present disclosure.

FIG. 7 is a diagram illustrating an example process performed, for example, by a second audio device, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

In some networks, a wireless communication device (WCD) may support applications associated with low-latency or lossless audio to one or more other devices, such as one or more personal audio devices. For example, a WCD may support applications and use cases associated with ultra-low-latency (ULL), such as ULL gaming, or streaming lossless audio to one or more personal audio devices (e.g., peripheral devices) of a user. In scenarios in which a user uses two peripheral devices, the WCD may support an extended personal area network (XPAN) via which the WCD may communicate with the two peripheral devices. To meet a latency or lossless criteria associated with an application or use case, XPAN devices may employ a target wake time (TWT) technique for communication between the WCD and the peripheral devices. In some systems, the peripheral devices and the WCD may exchange one or more Bluetooth messages and implement a complete TWT teardown between the WCD and each of the peripheral devices. Such an exchange of Bluetooth messages and TWT teardown may introduce too much latency for some applications, such as ULL gaming or streaming lossless audio applications.

In some implementations, a WCD, which may be a handset or an access point (AP) (e.g., a soft AP (SAP)), and a set of peripheral devices (e.g., earbuds or audio devices) may use downlink audio data packets to carry updated TWT parameters or any other XPAN-related parameters that the WCD and the peripheral devices may indicate via wireless signaling. In some examples, the WCD may embed a set of updated parameters (e.g., updated TWT parameters or other parameters associated with the XPAN) in one or more fields of a real-time transport protocol (RTP) audio header of an audio data packet and may transmit the audio data packet to the peripheral devices. Additionally, or alternatively, the WCD may embed a set of updated parameters in a padding section of an audio data packet and may transmit the audio data packet to the peripheral devices. The peripheral devices may each acknowledge the audio data packet transmitted by the WCD, and the WCD may communicate in accordance with the updated parameters based on receiving the acknowledgement from each of the peripheral devices.

Aspects of the disclosure are initially described in the context of a WCD. Aspects of the disclosure are additionally illustrated by and described with reference to a process flow, audio data packets (e.g., audio data packet formats), a communication timeline, encoding formats, and example XPAN topologies. Aspects of the disclosure are further illustrated by and described with reference to apparatus diagrams, system diagrams, and flowcharts that relate to low-latency parameter updates for XPANs.

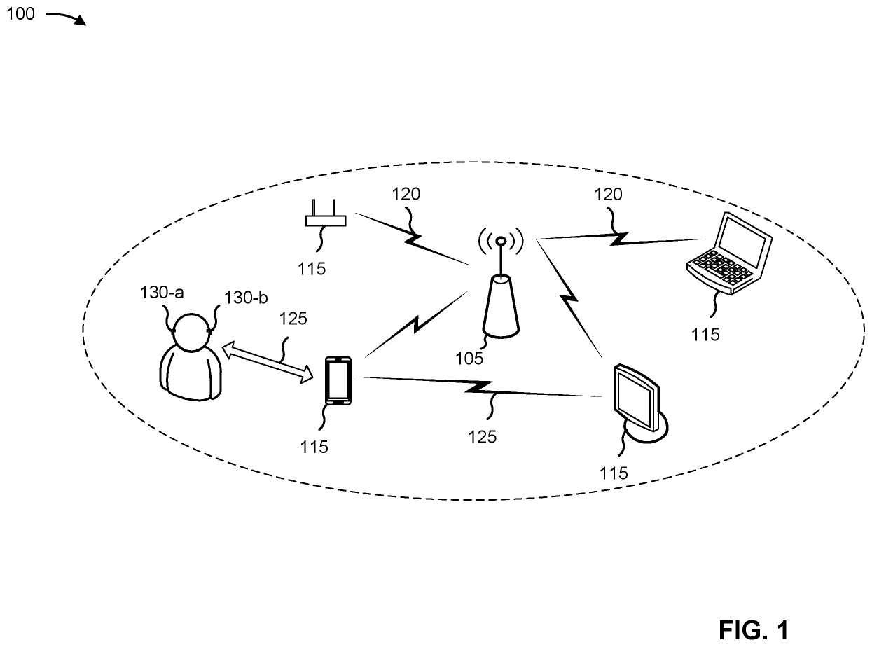

FIG. 1 illustrates a wireless communications system 100 (also known as a wireless local area network (WLAN) or a Wi-Fi network) configured in accordance with the present disclosure. The wireless communications system 100 may include an AP 105 and multiple associated devices 115 (such as stations (STAs) or SAPs, which may represent devices such as mobile stations, personal digital assistant (PDAs), other handheld devices, netbooks, notebook computers, tablet computers, laptops, display devices (e.g., TVs, computer monitors, etc.), printers, etc.). The AP 105 and the associated devices 115 (e.g., associated STAs) may represent a basic service set (BSS) or an extended service set (ESS). The various devices 115 in the network are able to communicate with one another through the AP 105. Also shown is a coverage area 110 of the AP 105, which may represent a basic service area (BSA) of the wireless communications system 100. An extended network station (not shown) associated with the wireless communications system 100 may be connected to a wired or wireless distribution system that may allow multiple APs 105 to be connected in an ESS.

Although not shown in FIG. 1, a device 115 may be located in the intersection of more than one coverage area 110 and may associate with more than one AP 105. A single AP 105 and an associated set of devices 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The wireless communications system 100 may include APs 105 of different types (e.g., metropolitan area, home network, etc.) with varying and overlapping coverage areas 110. Two devices 115 may also communicate directly via a direct wireless communication link 125 regardless of whether both devices 115 are in the same coverage area 110. Examples of direct wireless communication links 120 may include Wi-Fi Direct connections, Wi-Fi Tunneled Direct Link Setup (TDLS) links, and other group connections. Devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.1ah, 802.11ax, etc. In other implementations, peer-to-peer connections or ad hoc networks may be implemented within wireless communications system 100.

In some cases, a device 115 (or an AP 105) may be detectable by a central AP 105, but not by other devices 115 in the coverage area 110 of the central AP 105. For example, one device 115 may be at one end of the coverage area 110 of the central AP 105 while another device 115 may be at the other end. Thus, both devices 115 may communicate with the AP 105 but may not receive the transmissions of the other. This may result in colliding transmissions for the two devices 115 in a contention-based environment (e.g., carrier sense multiple access with collision avoidance (CSMA/CA)) because the devices 115 may not refrain from transmitting on top of each other. A device 115 whose transmissions are not identifiable, but that is within the same coverage area 110, may be known as a hidden node. CSMA/CA may be supplemented by the exchange of a request to send (RTS) packet transmitted by a sending device 115 (or AP 105) and a clear to send (CTS) packet transmitted by the receiving device 115 (or AP 105). This may alert other devices within range of the sender and receiver not to transmit for the duration of the primary transmission. Thus, RTS and/or CTS may help mitigate a hidden node problem.

The wireless communications system 100 may include an AP 105, devices 115 (e.g., which may be referred to as source devices, central devices, etc.), and paired devices 115 (e.g., which may be referred to as sink devices, peripheral devices, etc.) implementing WLAN communications (e.g., Wi-Fi communications) and/or Bluetooth communications. For example, devices 115 may include cell phones, user equipment (UEs), wireless stations (STAs), mobile stations, PDAs, other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 115), which may include wireless audio devices (e.g., headsets, earbuds, speakers, earpieces, headphones), display devices (e.g., TVs, computer monitors), microphones, meters, valves, etc.

Bluetooth communications may refer to a short-range communication protocol and may be used to connect and exchange information between devices 115 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a central-peripheral relationship employing a time-division duplex protocol having, for example, defined time slots of 625 microseconds, in which transmission alternates between the central device (e.g., a device 115) and one or more peripheral devices (e.g., paired devices 115). In some examples, a device 115 may generally refer to a central device, and a paired device 115 may refer to a peripheral device in the wireless communications system 100. As such, in some examples, a device may be referred to as either a device 115 or a paired device 115 based on the Bluetooth role configuration of the device. That is, designation of a device as either a device 115 or a paired device 115 may not necessarily indicate a distinction in device capability, but rather may refer to or indicate roles held by the device in the wireless communications system 100. Generally, device 115 may refer to a WCD capable of wirelessly exchanging data signals with another device (e.g., a paired device 115), and paired device 115 may refer to a device operating in a peripheral role, or to a short-range WCD capable of exchanging data signals with the device 115 (e.g., using Bluetooth communication protocols).

A communication link 125 may be established between two Bluetooth-enabled devices (e.g., between a device 115 and a paired device 115) and may provide for communications or services (e.g., according to some Bluetooth profile). The controller stack may be responsible for setting up communication links 125 such as asynchronous connection-oriented links (or asynchronous connection-oriented connections), synchronous connection-orientated (SCO) links (or SCO connections), extended synchronous connection-oriented (eSCO) links (or eSCO connections), other logical transport channel links, etc. For example, a Bluetooth connection may be an eSCO connection for a voice call (e.g., which may allow for retransmission), an asynchronous connection-less (ACL) connection for music streaming (e.g., advanced audio distribution profile (A2DP)), etc. eSCO packets may be transmitted in predetermined time slots (e.g., 6 Bluetooth slots each for eSCO). The regular interval between the eSCO packets may be specified when the Bluetooth link is established. The eSCO packets to/from a specific device (e.g., paired device 115) are acknowledged, and may be retransmitted if not acknowledged during a retransmission window. In addition, audio may be streamed between a device 115 and a paired device 115 using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 115 may support WLAN communications via AP 105 (e.g., over communication links 120). The AP 105 and the associated devices 115 may represent a BSS or an ESS. The various devices 115 in the network may be able to communicate with one another through the AP 105. In some cases the AP 105 may be associated with a coverage area, which may represent a BSA.

Devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100, and devices may communicate with each other via communication links 120 (e.g., Wi-Fi Direct connections, Wi-Fi TDLS links, peer-to-peer communication links, other peer or group connections). AP 105 may be coupled to a network, such as the Internet, and may enable a device 115 to communicate via the network (or communicate with other devices 115 coupled to the AP 105). A device 115 may communicate with a network device bi-directionally. For example, in a WLAN, a device 115 may communicate with an associated AP 105 via downlink (e.g., the communication link from the AP 105 to the device 115) and uplink (e.g., the communication link from the device 115 to the AP 105).

In some examples, content, media, audio, etc. exchanged between a device 115 and a paired device 115 may originate from a WLAN. For example, in some examples, device 115 may receive audio from an AP 105 (e.g., via WLAN communications), and the device 115 may then relay or pass the audio to the paired device 115 (e.g., via Bluetooth communications). In some examples, certain types of Bluetooth communications (e.g., such as high quality or high definition (HD) Bluetooth) may require enhanced quality of service. For example, in some examples, delay-sensitive Bluetooth traffic may have higher priority than WLAN traffic.

In some deployments, a WCD may support applications associated with low-latency or lossless audio to one or more other devices, such as one or more personal audio devices. For example, a WCD may support applications and use cases associated with ULL, such as ULL gaming, or streaming lossless audio to one or more personal audio devices (e.g., peripheral devices) of a user. In scenarios in which a user uses two peripheral devices (e.g., a wireless earbud 130-a and a wireless earbud 130-b), the WCD may support an XPAN via which the WCD may communicate with the two peripheral devices.

To meet a latency or lossless criteria associated with an application or use case, XPAN devices may employ a TWT technique for communication between the WCD and the peripheral devices. Initial or default TWT parameters may be set under an expectation for ideal (e.g., interference-free or approximately interference-free) conditions and may be updated in response to changing channel conditions or a changing concurrency situation at the WCD. In some systems, the peripheral devices and the WCD may exchange one or more Bluetooth messages and implement a complete TWT teardown between the WCD and each of the peripheral devices. Such an exchange of Bluetooth messages and TWT teardown may introduce too much latency for some applications, such as ULL gaming or streaming lossless audio applications.

In some implementations, a WCD, which may be a device 115 (e.g., a handset) or an AP 105, and a set of peripheral devices may use downlink audio data packets to carry updated TWT parameters or any other XPAN-related parameters that the WCD and the peripheral devices may indicate via wireless signaling. In some examples, the WCD may embed a set of updated parameters (e.g., updated TWT parameters or other parameters associated with the XPAN) in one or more fields, such as one or more contributing source (CSRC) fields, of an RTP audio header of an audio data packet and may transmit the audio data packet to the peripheral devices. Additionally, or alternatively, the WCD may embed a set of updated parameters in a padding section of an audio data packet and may transmit the audio data packet to the peripheral devices. The peripheral devices may each acknowledge the audio data packet transmitted by the WCD and the WCD may communicate in accordance with the updated parameters based on receiving the acknowledgement from each of the peripheral devices.

In accordance with the example implementations described herein, various devices may use over-the-air transmissions to indicate updated parameters (e.g., updated XPAN-related parameters, such as updated TWT parameters) via one or both of RTP audio header CSRC fields or padding fields in a payload data section. As such, the various devices may use a sequence of over-the-air packet transmissions to change or update a set of parameters (e.g., a set of TWT parameters). For example, via audio data packet transmissions, the various devices may configure, trigger, or indicate an increase or a decrease in audio packet periodicity (e.g., when TWT SI is changed). Further, in accordance with the described techniques, such devices may avoid an explicit TWT teardown, request, and response frame exchange and may instead achieve a TWT sequence change after RTP audio header CSRC fields or padding section indicates updated TWT parameters.

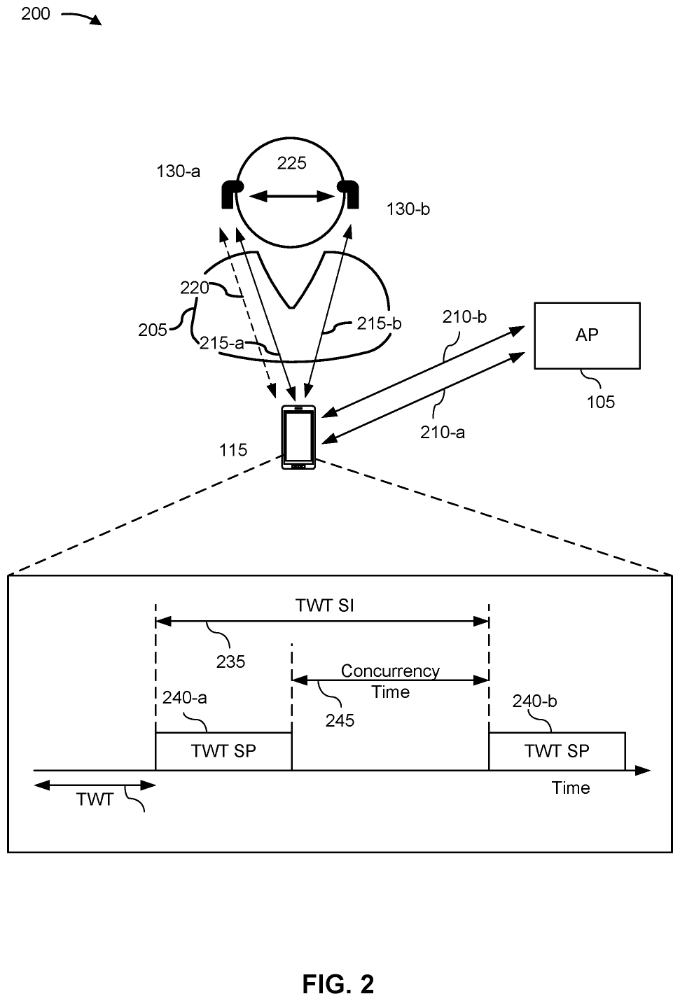

FIG. 2 illustrates an example of a wireless communications system Error! Reference source not found.00 that supports low-latency parameter updates for extended personal area networks, in accordance with one or more aspects of the present disclosure. The wireless communications system 200 may implement or be implemented to realize aspects of the wireless communications system 100. For example, the wireless communications system 200 illustrates communication between an AP 105, a device 115 (e.g., a handset or handheld device), and a wireless earbud 130-a and a wireless earbud 130-b of a user 205 (e.g., examples of audio devices and/or peripheral devices), which may be examples of corresponding devices as illustrated by and described with reference to FIG. 1. In some implementations, the device 115, the wireless earbud 130-a, and the wireless earbud 130-b may support a signaling-based mechanism according to which the device 115 may transmit an indication of a set of updated parameters to each of the wireless earbud 130-a and the wireless earbud 130-b via one or audio data packets.

In some deployments, the device 115 may communicate with the AP 105 via one or both of a link 210-a and a link 210-b, which may be examples of infrastructure links between the AP 105 and the device 115. The link 210-a may be an example of a 2.4 GHz link between the AP 105 and the device 115, and the link 210-b may be an example of a 5 GHz link or a 6 GHz link between the AP 105 and the device 115. Further, the device 115 may communicate wirelessly with each of the wireless earbud 130-a and the wireless earbud 130-b, where each of the wireless earbud 130-a and the wireless earbud 130-b may be associated with an XPAN of the device 115. For example, the device 115 may communicate with the wireless earbud 130-a via a link 215-a and may communicate with the wireless earbud 130-b via a link 215-b, where the link 215-a and the link 215-b may be referred to or understood as XPAN links. The link 215-a may be an example of a 5 GHz link or a 6 GHz link and the link 215-b may be an example of a 5 GHz link or a 6 GHz link. Additionally, in some examples, the device 115 may communicate with the wireless earbud 130-a, which may be an example of a primary earbud, via a communication link 220. The communication link 220 may be an example of a Bluetooth link between the device 115 and the wireless earbud 130-a. The wireless earbud 130-a and the wireless earbud 130-b, which may be an example of a secondary earbud, may communicate with each other via a link 225, which may be an example of a Bluetooth link between the wireless earbud 130-a and the wireless earbud 130-b.

In some cases, the device 115, the wireless earbud 130-a, and the wireless earbud 130-b may support or belong to an XPAN and may use the XPAN to support one or more applications or use cases, such as applications or use cases associated with a latency or lossless audio constraint or criteria. For example, the device 115 may support one or more use cases of ULL gaming and streaming lossless audio to the wireless earbud 130-a and the wireless earbud 130-b (e.g., personal devices of the device 115). For such applications, the device 115 may be expected to keep end-to-end latency below a relatively stringent latency target (e.g., 40 milliseconds (ms) for ULL gaming). Further, the device 115 may also be tasked with handling (e.g., gracefully handling) a coexistence of XPAN traffic (e.g., traffic to or from one or both of the wireless earbud 130-a and the wireless earbud 130-b) with other concurrency scenarios the user 205 or the system may initiate. Such other concurrency scenarios may include a scan concurrency for channel selection, STA infrastructure link concurrency for online gaming or other traffic to or from the AP 105, or neighbor aware networking (NAN) discovery and NAN data transfer, or any combination thereof.

As such, the device 115 may be expected to meet a latency constraint for various applications or use cases (e.g., an ultra-low-latency constraint for a ULL gaming use case) and also facilitate coexistence between XPAN and other concurrency scenarios on the device 115. To meet the latency constraints associated with, for example, ULL gaming, a power constraint of the wireless earbud 130-a and the wireless earbud 130-b, power and concurrency constraints at the device 115, the device 115 may employ a TWT technique for the communication between the device 115 (which may act or function as a SAP) and each of the wireless earbud 130-a and wireless earbud 130-b (which may act or function as STAs).

Example TWT parameters include a TWT 230, a TWT service interval (SI) 235, and a TWT service period (SP) 240. A TWT 230 may indicate or be associated with a timing synchronization function (TSF) time indicating a start or beginning of a first TWT session. A TWT SI 235 may indicate a TWT interval, which may refer to a time difference between a start or beginning of two consecutive TWT sessions. A TWT SP 240 may indicate a duration during which one or both of the wireless earbud 130-a and the wireless earbud 130-b are awake during a TWT SI 235. In some aspects, a TWT SP 240 may be referred to or understood as a TWT session. As such, and as illustrated by FIG. 2, the TWT SI 235 may indicate a time difference between a TWT SP 240-a and a TWT 240-b. A remainder of time within a TWT SI 235 excluding a TWT SP 240 may be referred to or understood as a concurrency time 245 during which the device 115 may perform any operations (e.g., transmission or reception) associated with a concurrency scenario at the device 115. In other words, the difference between XPAN TWT SI 235 and XPAN TWT SP 240 may be the time left for the device 115 to support other concurrencies (e.g., outside of any channel switching or software overheads).

For XPAN, each of the wireless earbud 130-a and the wireless earbud 130-b (which may be examples of TWT requesting STAs) may initiate a TWT session with the device 115 (which may be an example of a TWT responding STA). Further, for low-latency use cases (e.g., ULL gaming use cases), a target end-to-end latency may be relatively stringent (e.g., less than or equal to approximately 40 ms), which may be tied to, associated with, or expect a Wi-Fi latency in a specific range (e.g., in the sub-10 ms range). To achieve such a Wi-Fi latency, a TWT SI 235 and a TWT SP 240 may be selected or set to specific values (e.g., a TWT SI 235 may be set to 4 ms with a TWT SP 240 of 2 ms). Further, for a lossless audio use case, for example, a TWT SI 235 may be set to approximately 70 ms with a TWT SP 240 of approximately 23 ms.

In some cases, a default or initial set of TWT parameters for XPAN may be configured or set expecting ideal (e.g., interference-free or approximately interference-free) conditions (e.g., link conditions, channel conditions, or environmental conditions). In some deployments, Wi-Fi channel conditions, a concurrency situation of the device 115, or XPAN constraints may change over time. Such changes may trigger, be associated with, or mandate a TWT parameter update. Further, in applications or use cases associated with low-latency (e.g., ULL gaming and streaming lossless audio), the TWT parameter update may be expected to be performed with low latency to continue to meet XPAN constraints without compromising a user experience. As an example, for XPAN gaming use cases, a TWT SP 240 may be approximately 2 ms. As such, a communication overhead of the updated TWT parameters, or other information communicated from the device 115 to the wireless earbud 130-a and the wireless earbud 130-b, may also be expected to be relatively small.

In some systems, however, a TWT parameter update procedure may be associated with a relatively high latency. Further, because TWT sessions may be initiated by the wireless earbud 130-a and the wireless earbud 130-b (with default or initial parameters), any update for TWT parameters triggered by a condition change on the device 115 may involve the device 115 transmitting the updated parameters to the wireless earbud 130-a and the wireless earbud 130-b followed by a TWT parameter change at the wireless earbud 130-a and the wireless earbud 130-b.

An example TWT parameter update procedure may include a sequence of signaling steps that involve one or more transmissions using a Bluetooth link, which may introduce relatively large delays. For example, a Wi-Fi sub-system (SS) of the device 115 may send, to a Bluetooth host (BT host) of the device 115, a request (e.g., a TWT parameter update request) to update one or more TWT parameters after one or more conditions are detected that trigger one or more TWT parameter changes. The BT host of the device 115 may communicate an updated set of TWT parameters to a BT host of a primary earbud (e.g., the wireless earbud 130-a) using a Bluetooth link. Such an updated TWT configuration sent via a Bluetooth link may add approximately 80 ms of delay. The BT host of the primary earbud may signal the new TWT parameters internally to a Wi-Fi SS of the primary earbud, and the BT host of the primary earbud may communicate the new TWT parameters to a BT host of a secondary earbud (e.g., the wireless earbud 130-b) using a Bluetooth link. Such an indication of a TWT configuration via a Bluetooth link between the primary earbud and the secondary earbud may add approximately 120 ms of delay. The BT host of the secondary earbud may signal the new TWT parameters internally to a Wi-Fi SS of the secondary earbud.

The Wi-Fi SS of the primary earbud may start a TWT session teardown and parameter update process. The TWT session tear down and parameter update process may involve a transmission, from the Wi-Fi SS of the primary earbud to the Wi-Fi SS of the device 115 via an XPAN Wi-Fi link, of a TWT teardown message and a TWT request message that carries the new TWT parameters and a transmission, from the Wi-Fi SS of the device 115 to the Wi-Fi SS of the primary earbud via the XPAN Wi-Fi link, of an acknowledgement (ACK) of the new TWT parameters with a TWT response message. The Wi-Fi SS of the device 115 may update the BT host of the device 115 that a new TWT session with the primary earbud has been established (e.g., the Wi-Fi SS may indicate a TWT session update to the BT host). Such a TWT session teardown and parameter update process may additionally be performed between the device 115 and the secondary earbud.

In accordance with such a TWT parameter update procedure, the device 115 may incur a relatively large delay between the time a condition is triggered on the device 115 associated with a TWT parameter update and the time the updated parameters take effect. For example, some components of the delay may include a delay of approximately 80 ms associated with the updated TWT configuration sent via the Bluetooth link between the device 115 and the primary earbud, a delay of approximately 100 ms associated with a sniff exit delay if the Bluetooth link between the two earbuds is in sniff mode, a delay of approximately 20 ms associated with the updated TWT configuration sent via the Bluetooth link between the two earbuds, and a delay of approximately 5 ms associated with the teardown of the TWT sessions and the re-establishment of new TWT sessions from both earbuds. Accordingly, such a TWT parameter update procedure may be associated with a total end-to-end delay of approximately 205 ms for a one-time TWT parameter update, which may be too much for some applications or use cases (e.g., ULL gaming and streaming lossless audio use cases).

In some implementations, the device 115, the wireless earbud 130-a, and the wireless earbud 130-b may support a data packet generation-based and signaling-based mechanism according to which the device 115 may embed an indication of one or more updated parameters in one or more audio data packets that the device 115 may transmit to the wireless earbud 130-a and the wireless earbud 130-b. For example, if the device 115 detects a change that triggers a parameter update, or if the device 115 otherwise determines to transmit a set of parameters to the wireless earbud 130-a and the wireless earbud 130-b with low latency, the device 115 may embed the parameters in one or more downlink audio data packets and may transmit the one or more downlink audio data packets to the wireless earbud 130-a and the wireless earbud 130-a. In some implementations, the device 115 may transmit an indication of the parameters to the wireless earbud 130-a via a first audio data packet transmitted using a first Wi-Fi link (e.g., a first XPAN Wi-Fi link) and may transmit an indication of the parameters to the wireless earbud 130-b via a second audio data packet transmitted using a second Wi-Fi link (e.g., a second XPAN Wi-Fi link). The first audio data packet and the second audio data packet may include the same information or may include different information, and each may be examples of physical layer convergence protocol (PLCP) protocol data units (PPDUs).

As such, the device 115 may convey a set of one or more parameters to both of the wireless earbud 130-a and the wireless earbud 130-b in the course of expected downlink data transmissions or traffic (e.g., without using any additional or dedicated signaling). In accordance with such a lack of additional over-the-air Bluetooth or Wi-Fi signaling between the device 115 and each of the wireless earbud 130-a and the wireless earbud 130-b, and between the wireless earbud 130-a and the wireless earbud 130-b, a total end-to-end delay may be one or a relatively small quantity of TWT SIs 235, which may correspond to a delay of approximately 4 or 8 ms for some applications or use cases (e.g., ULL gaming). Such a delay of approximately 4 or 8 ms may represent a significant cut down in end-to-end delay of TWT parameter renegotiation compared to other example parameter update procedures (which may incur delays of approximately 205 ms).

As such, the device 115, the wireless earbud 130-a, and the wireless earbud 130-b may achieve up to approximately 50× faster response time to any condition change on an XPAN or infrastructure link associated with the device 115. In other words, the described techniques may allow or facilitate an agile XPAN system that can adapt to changing wireless conditions associated with an XPAN or infrastructure link at the device 115. Accordingly, the described techniques may be applicable to any latency-sensitive applications or use cases using TWT as the communication protocol between potentially power-constrained devices or any other use cases that are associated with or expect low-latency XPAN parameter updates from a default or initial set of programmed values.

Further, the described techniques may allow or facilitate an updating of one or more TWT parameters at the same time and may additionally, or alternatively, be used for communicating any other information (XPAN-related or otherwise) between the device 115, the wireless earbud 130-a, and the wireless earbud 130-b in a fast and efficient way. For examples, the parameters that may be communicated between the device 115 and each of the wireless earbud 130-a and the wireless earbud 130-b may include a set of one or more TWT parameters, a receive signal strength indicator (RSSI) measured at either the device 115 or one or both of the wireless earbud 130-a and the wireless earbud 130-b that is expected to be communicated to the device 115 or one or both of the wireless earbud 130-a and the wireless earbud 130-b, a channel switch indication or request, or a bearer switch indication or request. Such one or more TWT parameters may include any one or more of a TWT SI 235, a TWT SP 240, or a TWT start time (e.g., a TWT 230). Further, such a bearer switch indication or request may be a request for a switch from an XPAN bearer to a Bluetooth bearer, or vice versa.

In some networks, a WCD may communicate with a first audio device and a second audio device. The first audio device may have a fixed start time (e.g., at a start of a periodic set of resources, such as a service interval, or at an offset from the start of the periodic set of resources) and a variable duration. The variable duration may be based at least in part on whether retransmissions are needed, a number of retransmissions, and/or a modulation and coding scheme (MCS) used for communicating with the first audio device, among other examples.

The second audio device may also have a fixed start time that is offset from the fixed start time of the first audio device. This may be based at least in part on an inability for the WCD to communicate with both audio devices simultaneously (e.g., based at least in part on interference and/or transmission capabilities, among other examples). In a first scenario, the second audio device may wake up and monitor for communications before the first audio device has completed communication with the WCD. In this scenario, the second audio device may waste power and computing resources to wake up before the WCD is ready to communicate with the second audio device. In a second scenario, the second audio device may not wake up and monitor for communications until a period of time after the first audio device has completed communication with the WCD (e.g., an offset of the fixed start time of the second audio device from the fixed start time of the first audio device is relatively large). In this scenario, the second audio device may waste concurrency time and/or the WCD may waste network resources during the period of time after the first audio device has completed communication with the WCD.

In some aspects described herein, a WCD may communicate, during a time period, with a first audio device (e.g., an earbud or other peripheral device) via a first wireless connection and with a second audio device (e.g., an earbud or other peripheral device) via a second wireless connection. Periodic communications with the first audio device may have a fixed start time and a first duration that is variable in length. Start times may be fixed based at least in part on the start times of TWT periods being known to the first audio device based at least in part on TWT setup messages. For example, if a TWT (e.g., a first start time) is 10 ms and TWT SI is 100 ms, the first earbud infers that TWT SIs would start at times 10, 110, 210, etc.

Periodic communications with the second audio device may have a start time (e.g., a variable and/or dynamic start time) and a second duration that is variable in length. The WCD may transmit, to the second audio device and based at least in part on detection of a change in the first duration, an indication of a second start time associated with the second audio device. The second start time may be different from the first start time. The second start time may be dynamic (e.g., based at least in part on a start time and duration of the periodic communications with the first audio device).

In some aspects, the second audio device may have a dynamic start time. For example, the WCD may begin with a fixed offset for the second audio device (assuming highest MCS for the left earbud and no retransmissions, and/or a shortest first earbud TWT SP, SP_{L,start}=SP_{L,min}). In an example with TWT SI=100 ms, 192 KHz/24 bits, and a maximum MCS of 3, the second audio device may have an initial offset of 16 ms. The WCD may translate the second audio device start offset into a second audio device Start Time (e.g., TSF start time). For example, TWT (second audio device)=TWT(first audio device)+SP_{L,start} (ideal parameters).

The WCD may communicate the second audio device Start Time to the second audio device via an Unsolicited TWT Response Message or other proprietary communication methods (e.g., a vendor-specific action frame). The WCD may keep track of a last SP of the first audio device used to communicate the second audio device TWT Start Time, SP_{first audio device,last} (SP_{first audio device,prev} is initialized to SP_{first audio device,start}).

In some aspects, the WCD may monitor an average TWT SP of the first audio device using a moving average as: avgSP_{first audio device}=α*SP_{first audio device, curr}+(1−α)*avgSP_{first audio device}. The first audio device TWT SP may vary based at least in part on first audio device channel condition, an MCS used for the first audio device, and/or a number of retransmissions used by the first audio device, among other examples.

If the average TWT SP of the left earbud avgSP_{first audio device} deviates from SP_{first audio device,last} by more than a hysteresis margin, the WCD calculates a new second audio device Start Time and communicates to the second audio device. For example, if(avgSP_{first audio device}−SP_{first audio device,prev})>SP_{hyst} (difference from average is greater than a threshold), the WCD may change the start time of the second audio device. In some aspects, SP_{first audio device,prev}=avgSP_{first audio device}, SP(first audio device, prev) is set to the average only when a change is made. The use of a hysteresis margin may be used to reduce unnecessary overhead of changing and communicating a new second audio device Start Time if the change in first audio device TWT SP is small. The hysteresis margin may be set as an absolute time value (e.g., SP_{hyst}=2 ms) or a percentage of the last first audio device SP (e.g., SP_{hyst}=β*SP_{first audio device,last}, β=5% for example).

In some aspects, if an audio device disconnects (e.g., runs out of battery or is put in the battery case), no change will happen to the start time of the other audio device (e.g., the start time would remain the same). Average SP tracking may be performed as long as the first audio device is active and connected to reduce WCD battery consumption and/or to increase WCD concurrency time. If the first audio device is disconnected, there is no need to update the second audio device TWT Start Time, since the WCD will only wake up for the second audio device, without impact to WCD power consumption nor WCD concurrency time.

Based at least in part on the second audio device having a dynamic start time, the second audio device may have increased concurrency time, may reduce unnecessary power consumption on the second audio device and/or the WCD, may support lossless audio with an MCS as low as 1, and/or may reduce imbalanced performance between both audio devices compared to a fixed start time for the second audio device where the second audio device may be allocated more TWT SP duration than the first audio device.

In some aspects, the WCD may include a communication manager. As described in more detail elsewhere herein, the communication manager may communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length; and transmit, to the second audio device and based at least in part on detection of a change in the first duration, an indication of a second start time, that is different from the first start time, associated with the second audio device. Additionally, or alternatively, the communication manager may perform one or more other operations described herein.

In some aspects, the second audio device and/or the first audio device may include a communication manager. As described in more detail elsewhere herein, the communication manager may communicate, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length; and receive, from the WCD and based at least in part on detection of a change in the first duration, an indication of a second start time, that is different from the first start time, associated with the second audio device. Additionally, or alternatively, the communication manager may perform one or more other operations described herein.

In some aspects, the WCD includes means for communicating, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length; and/or means for transmitting, to the second audio device and based at least in part on detection of a change in the first duration, an indication of a second start time, that is different from the first start time, associated with the second audio device. In some aspects, the means for the WCD to perform operations described herein may include, for example, one or more of a communication manager, a transmit processor, a TX multiple-input-multiple-output (MIMO) processor, a modem, an antenna, a MIMO detector, a receive processor, a controller/processor, a memory, or a scheduler, among other examples.

In some aspects, the second audio device includes means for communicating, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length; and/or means for receiving, from the WCD and based at least in part on detection of a change in the first duration, an indication of a second start time, that is different from the first start time, associated with the second audio device. In some aspects, the means for the second audio device to perform operations described herein may include, for example, one or more of a communication manager, a transmit processor, a TX MIMO processor, a modem, an antenna, a MIMO detector, a receive processor, a controller/processor, a memory, or a scheduler, among other examples.

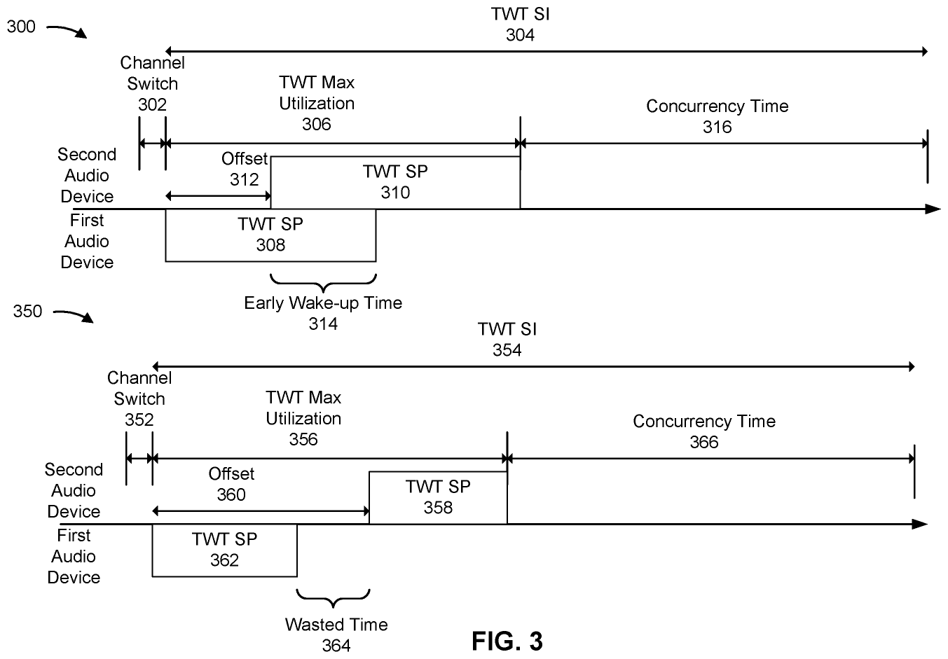

FIG. 3 is a diagram of an example associated with TWT SI communications involving a first audio device and a second audio device using time domain multiplexing. For example, the first audio device may use a first time resource of a TWT SI, and the second audio device may use a second time resource that begins later in time than the first time resource.

The first time resource may have a fixed beginning time (e.g., at a beginning of the TWT SI or after control information) and a variable duration. For example, the first time resource may have a variable duration that is based at least in part on an amount of data and/or control information to be communicated between the first audio device and a WCD (e.g., a UE, a host, and/or an audio source device, among other examples). The second time resource may have a fixed beginning time that is offset from the beginning of the TWT SI, from the control information, and/or from the beginning time of the first time resource.

As shown by reference number 300, the second time resource may have a fixed beginning time that is too early and wastes power and/or computing resources to attempt to receive communications while the first time resource is ongoing.

The WCD may configure a channel switch 302 as a period of time during which the WCD and/or the first audio device and the second audio device may switch channels (e.g., tuning hardware to communicate on an indicated channel). The WCD, the first audio device, and the second audio device may be configured to communicate during a TWT SI 304. The TWT SI may include a TWT maximum (max) utilization 306, after which communications involving the WCD with first audio device and the second audio device must cease.

Within the TWT maximum utilization 306, the first audio device may communicate with the WCD during a TWT SP 308 with a start time that is aligned with a start time of the TWT SI 304 or that is offset from the TWT SI 304 by an amount of time that is less than an offset associated with communications between the second audio device and the WCD. The second audio device may communicate with the WCD during a TWT SP 310 that is offset 312 such that the TWT SP 310 begins after the start time of the TWT SP 308.

As shown in example 300, when the offset 312 is too small, the TWT SP 310 may have a start time that is before an end time of the TWT SP 308. Based at least in part on the first audio device and the second audio device being time division multiplexed, only one can communicate with the WCD at a time. Based at least in part on the TWT SP 310 beginning before the second audio device can communicate with the WCD (e.g., based at least in part on the TWT SP 308 being ongoing), the second audio device may unnecessarily consume power and computing resources during an early wake-up time 314.

The TWT maximum utilization 306 may be followed by a concurrency time 316 during which the WCD does not communicate with the first audio device or the second audio device. For example, the concurrency time 316 may include time allocated for communications of other devices, scanning channels for occupancy, and/or communicating by the WCD with another device.

As shown by reference number 350, the second time resource may have a fixed beginning time that is too early and wastes power and/or computing resources to attempt to receive communications while the first time resource is ongoing.

The WCD may configure a channel switch 352 as a period of time during which the WCD and/or the first audio device and the second audio device may switch channels (e.g., tuning hardware to communicate on an indicated channel). The WCD, the first audio device, and the second audio device may be configured to communicate during a TWT SI 354. The TWT SI may include a TWT maximum utilization 356, after which communications involving the WCD with first audio device and the second audio device must cease.

Within the TWT maximum utilization 356, the first audio device may communicate with the WCD during a TWT SP 358 with a start time that is aligned with a start time of the TWT SI 354 or that is offset from the TWT SI 354 by an amount that is less than an offset associated with communications between the second audio device and the WCD. The second audio device may communicate with the WCD during a TWT SP 360 that is offset 362 such that the TWT SP 360 begins after the start time of the TWT SP 358.

As shown in example 350, when the offset 362 is too large, the TWT SP 360 may have a start time that is after an end time of the TWT SP 308. Based at least in part on the TWT SP 360 beginning after the second audio device could communicate with the WCD (e.g., based at least in part on the TWT SP 308 ending), the second audio device may unnecessarily waste network resources during wasted time 364 during which the WCD does not communicate with the first audio device or the second audio device.

The TWT maximum utilization 356 may be followed by a concurrency time 316 during which the WCD does not communicate with the first audio device or the second audio device. For example, the concurrency time 366 may include time allocated for communications of other devices, scanning channels for occupancy, and/or communicating by the WCD with another device.

As indicated above, FIG. 3 is provided as an example. Other examples may differ from what is described with respect to FIG. 3.

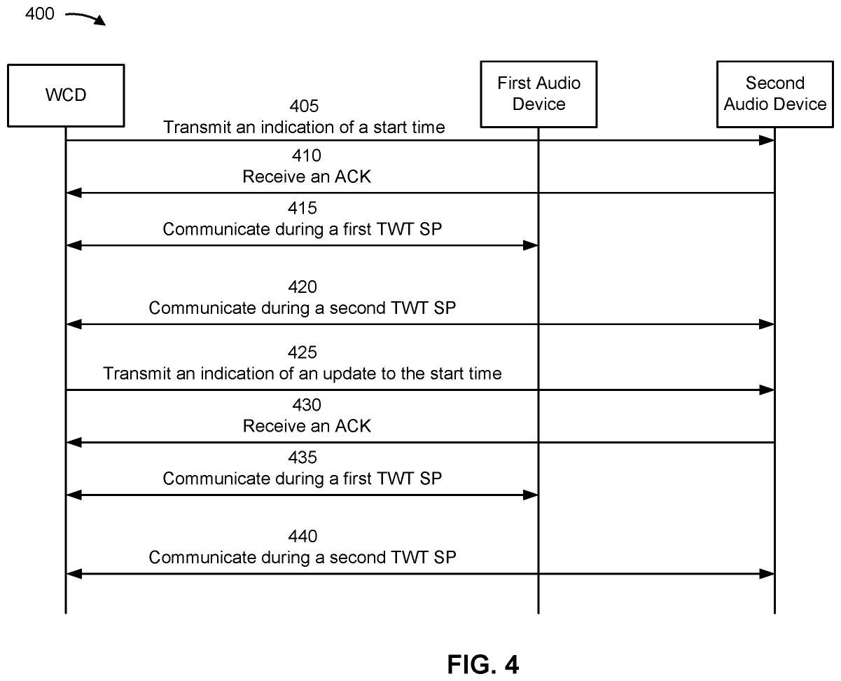

FIG. 4 is a diagram of an example 400 associated with dynamic start times for periodic communications of an audio device, in accordance with the present disclosure. As shown in FIG. 4, a WCD (e.g., a UE, a host device, and/or and audio source, among other examples) may communicate with a first audio device and a second audio device (e.g., 130-a and 130-b, respectively). In some aspects, the WCD, the first audio device, and the second audio device may have established a wireless connection prior to operations shown in FIG. 4.

As shown by reference number 405, the WCD may transmit an indication of a start time to the second audio device. In some aspects, the indication of the start time may include an indication of an offset from a beginning of a TWT SI, such that the start time is relative to the beginning of the TWT SI. The start time may be later than a start time of communications between the WCD and the first audio device.

In some aspects, the WCD may transmit the indication of the start time via a configuration communication. The WCD may broadcast, multicast, and/or unicast the configuration information (e.g., the first audio device may also receive the configuration information). In some aspects, the configuration information may provide parameters for communicating using TWT-based communication scheduling. For example, the configuration information may configure time resources that are to be used for communications between the WCD and the first audio device and the second audio device.

In some aspects, the indication of the start time may indicate a minimum length of a duration of a communication with the first audio device. In some aspects, the second audio device may assume a start time that is based at least in part on the minimum length of the duration of the communication with the first audio device (e.g., in the absence of receiving the indication of the start time).

As shown by reference number 410, the WCD may receive an ACK from the second audio device, with the ACK associated with the indication of the start time. In some aspects, based at least in part on receiving the ACK, the WCD may synchronize the start time, with the second audio device, for communications during a period of time. In some aspects, if the WCD fails to receive an ACK, the WCD may re-transmit the indication of the start time to the second audio device.

As shown by reference number 415, the WCD may communicate with the first audio device during a first TWT SP (e.g., a first time period) that is associated with the first audio device. In some aspects, the WCD may communicate with the first audio device via a first wireless connection. The WCD may communicate with the first audio device using periodic communications, with the periodic communications having a fixed start time (e.g., relative to a start of a TWT SI) and a first duration that is variable in length. The start time may be fixed based at least in part on the start times of TWT periods being known to the first audio device based at least in part on TWT setup messages. For example, if a TWT (e.g., a first start time) is 10 ms and TWT SI is 100 ms, the first earbud infers that TWT SIs would start at times 10, 110, 210, etc.

In some aspects, the start time of the first audio device (and/or the WCD) may be changed (e.g., updated via a TWT update message). Once updated, the start time of the first audio device becomes fixed until a further update. In this way, the start time of the first audio device may be considered semi-static for a duration, and during that duration, the start time of the second audio device is dynamic relative to the first start time. If for any reason, the start time of the first audio device is updated, the WCD may send a TWT update message and the new start time of the first audio device would act as the new “fixed” reference for a “super-cycle” until a further change happens. In this way, a “super-cycle” is associated with the first audio device, and within that super cycle, there could be multiple “cycles” with variable start times of the second device.

As shown by reference number 420, the WCD may communicate with the second audio device during a second TWT SP that is associated with the second audio device. In some aspects, the WCD may communicate with the second audio device via a second wireless connection. The WCD may communicate with the second audio device using periodic communications, with the periodic communications having a start time (e.g., relative to a start of a TWT SI) and a second duration that is variable in length.

As shown by reference number 425, the WCD may transmit an indication of an update to the start time. For example, the start time described in connection with reference number 405 may be a first start time that applies to a first set of one or more periodic communications. The update to the start time described in connection with reference number 425 may be a second start time that applies to a second set of one or more periodic communications (e.g., after the first set of one or more periodic communications). The second start time may be different from the first start time based at least in part on detection of a change in the first duration (e.g., longer or shorter).

In some aspects, the change in the first duration is based at least in part on one or more changes associated with a channel condition of the first wireless connection, an MCS of the first wireless connection, a number of retransmissions of the first wireless connection, or an audio quality metric of the first wireless connection. In some aspects, the change in the first duration is relative to a reference value of the first duration. For example, the reference value of the first duration may include an average length of the first duration (e.g., a weighted average).

In some aspects, the first start time of communications of the second audio device may be based at least in part on the reference value, and the second start time of communications of the second audio device may be based at least in part on a change of the average first duration relative to the reference value. For example, based at least in part on an average first duration varying from the reference value (e.g., of the average first duration from previous communications), the WCD may update the start time. In some aspects, detection of the change in the first duration includes a detection of an amount of change that satisfies a change threshold (e.g., the variation from the reference value satisfies the change threshold). In some aspects, the change threshold includes a percentage change from a reference value or an absolute time value difference (e.g., a number of milliseconds) between the first duration and the reference value, among other examples.

In some aspects, transmission of the indication of the first start time (described in connection with reference number 405) or transmission of the indication of the second start time (described in connection with reference number 425) includes transmitting an indication via an unsolicited TWT communication or transmitting the indication via a vendor-specific action frame.

As shown by reference number 430, the WCD may receive an ACK from the second audio device.

As shown by reference number 435, the WCD may communicate with the first audio device during a first TWT SP.

As shown by reference number 440, the WCD may communicate with the second audio device during a second TWT SP that is based at least in part on the indication of the update to the start time. In some aspects, the WCD may communicate with the second audio device using the second start time based at least in part on receiving an ACK associated with the indication. Alternatively, the WCD may retransmit the indication based at least in part on failing to receive the ACK associated with the indication.

In some aspects, the WCD may identify a disconnection of the first wireless connection and may continue using the start time for the second TWT SP until identification of a reconnection of the first wireless connection or a disconnection of the second wireless connection.

Based at least in part on using a start time that is updateable for the second audio device, the WCD may conserve network resources that may have otherwise been consumed by having too long of a fixed offset for the start time. Additionally, or alternatively, the second audio device may conserve power and computing resources that may have otherwise been consumed by attempting to communicate with the WCD before communications are possible. Based at least in part on the fixed offset being too short.

As indicated above, FIG. 4 is provided as an example. Other examples may differ from what is described with respect to FIG. 4.

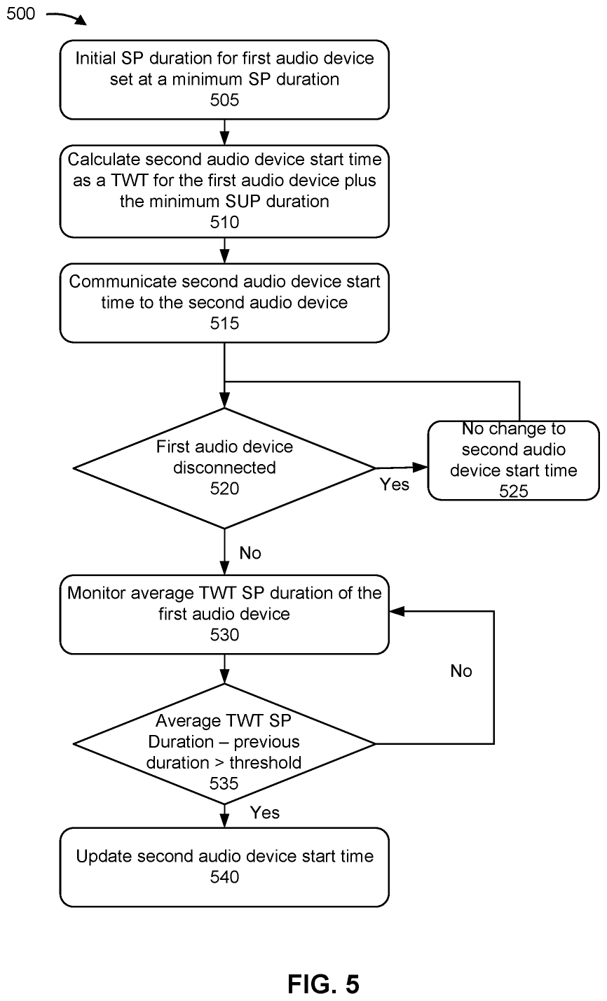

FIG. 5 is a diagram of an example 500 associated with dynamic start times for periodic communications of an audio device, in accordance with the present disclosure. In context of FIG. 4, a WCD (e.g., a UE, a host device, and/or and audio source, among other examples) may communicate with a first audio device and a second audio device (e.g., 130-a and 130-b, respectively). In some aspects, the WCD, the first audio device, and the second audio device may have established a wireless connection prior to operations shown in FIG. 5.

As shown by reference number 505, the WCD may set an initial SP duration (SP_{L,start}) for the first audio device at a minimum SP duration. The WCD may start with a fixed offset for the second audio device (assuming a highest MCS for the first audio device and no retransmissions, which may be based at least in part on a shortest first audio device TWT SP, SP_{L,start}=SP_{L,min})

In an example where TWT SI=100 ms, 192 KHz/24 bits, max MCS of 3, the second audio device may have a start time with an offset=16 ms.

As shown by reference number 510, the WCD may calculate a second audio device start time as a TWT for the first audio device (e.g., a start time) plus the minimum SP duration. In some aspects, the WCD may translate a second audio device start offset into a second audio device start time (TSF), TWT_{R}=TWT_{L}+SP_{L,min}

As shown by reference number 515, the WCD may communicate (e.g., transmit an indication of) the second audio device start time to the second audio device. In this way, the second audio device may be synchronized with the WCD on TWT SP start times.

In some aspects, the WCD may communicate the second audio device start time to the second audio device using an Unsolicited TWT Response Message or other proprietary communication methods (e.g., a vendor-specific action frame). The WCD may track the last SP of the first wireless device that the WCD used to communicate the second audio device TWT start time, SP_{L,last} (SP_{L,prev} may be initialized to SP_{L,start}).

As shown by reference number 520, the WCD may determine if the first audio device is disconnected. As shown by reference number 525, if the first audio device is disconnected, the WCD may make no change to the second audio device start time.

As shown by reference number 530, if the first audio device is not disconnected the WCD may monitor an average TWT SP duration of the first audio device. In some aspects, the WCD may monitor the average TWT SP of the first audio device using a moving average, such as avgSP_{L}=α*SP_{L,curr}+(1−α)*avgSP_{L}. In some aspects, the first audio device TWT SP duration may vary based at least in part on channel conditions, MCS used, and/or a number of retransmissions associated with communications with the first audio device.

As shown by reference number 535, the WCD may determine if a different between an average TWT SP duration and a previous duration satisfies a threshold. For example, the WCD may determine whether an average TWT SP duration of recent TWT SPs with the first audio device differs from a previous average TWT SP duration that was used to configure a current second audio device start time. If the difference fails to satisfy the threshold, the WCD may continue monitoring the difference.

If the average TWT SP of the left earbud avgSP_{L} deviates from SP_{L,last} by more than a hysteresis margin (e.g., the threshold), the WCD may calculate a new second audio device start time and communicate the new second audio device start time to the second audio device. For example, if(avgSP_{L}−SP_{L,prev})>SP_{hyst} (e.g., a difference from a previous average is greater than a threshold), the WCD may determine to update a start time for the second audio device.

The use of a hysteresis margin and/or threshold may reduce unnecessary overhead of changing and communicating a new second audio device start time if a change in the first audio device SP duration is relatively small. The hysteresis margin can be set as an absolute time value (e.g., SP_{hyst}=2 ms) or a percentage of a previous (last) first audio device SP duration (e.g., SP_{hyst}=β*SP_{L,last}, β=5% for example.

As shown by reference number 540, based at least in part on the WCD determining that the difference satisfies the threshold, the WCD may update the second audio device start time. In some aspects, the WCD may update a value of a previous average first audio device SP duration based at least in part on updating the second audio device start time. For example, SP_{L,prev}=avgSP_{L}, SP(L,prev) may be set to the average value only when a change is made to the second audio device start time. In this way, a current second audio device start time may be associated with a previous average first audio device SP duration that was used to determine the current second audio device start time.

As indicated above, FIG. 5 is provided as an example. Other examples may differ from what is described with respect to FIG. 5.

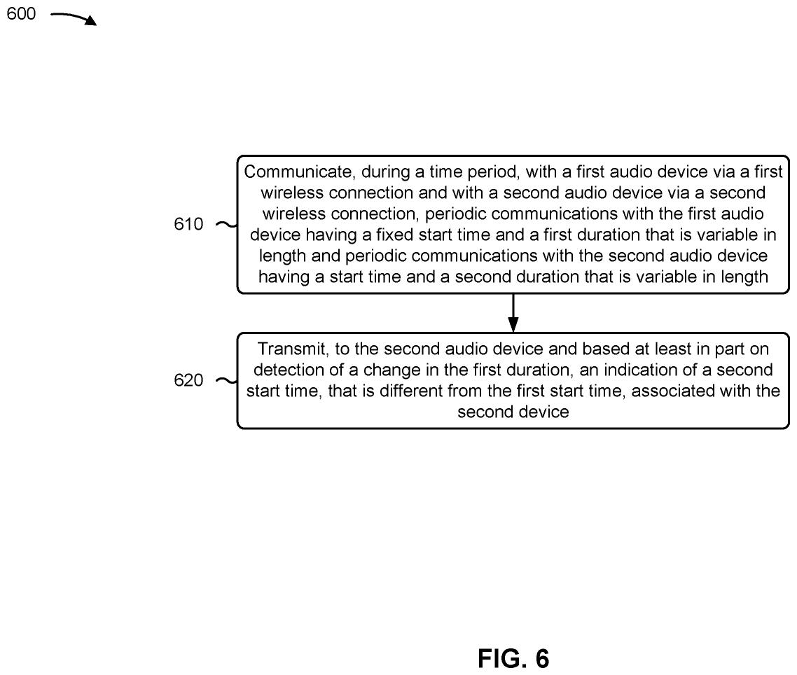

FIG. 6 is a diagram illustrating an example process 600 performed, for example, by a WCD, in accordance with the present disclosure. Example process 600 is an example where the WCD (e.g., WCD 115) performs operations associated with trigger conditions for switching service intervals and service periods.

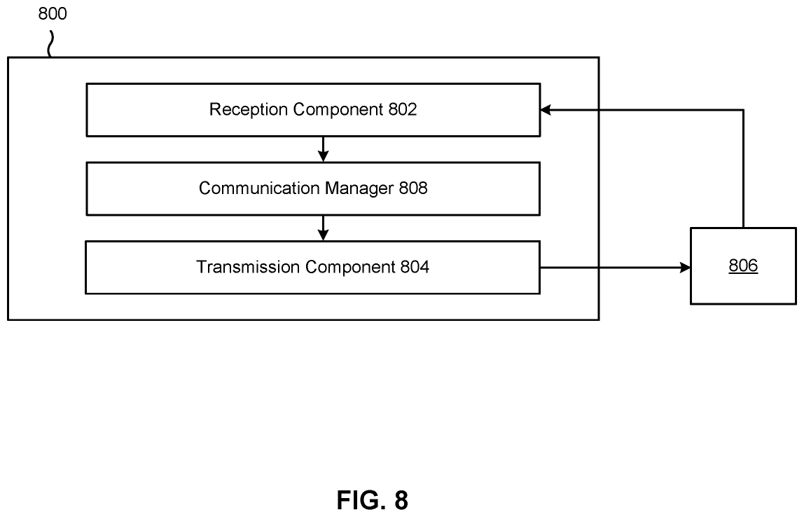

As shown in FIG. 6, in some aspects, process 600 may include communicating, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length (block 610). For example, the WCD (e.g., using communication manager 808, reception component 802, and/or transmission component 804 depicted in FIG. 8) may communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length, as described above.

As further shown in FIG. 6, in some aspects, process 600 may include transmitting, to the second audio device and based at least in part on detection of a change in the first duration, an indication of a second start time, that is different from the first start time, associated with the second audio device (block 620). For example, the WCD (e.g., using transmission component 804 depicted in FIG. 8) may transmit, to the second audio device and based at least in part on detection of a change in the first duration, an indication of a second start time, that is different from the first start time, associated with the second audio device, as described above.

Process 600 may include additional aspects, such as any single aspect or any combination of aspects described below and/or in connection with one or more other processes described elsewhere herein.

In a first aspect, the change in the first duration is based at least in part on one or more changes associated with one or more of a channel condition of the first wireless connection, a MCS, a number of retransmissions, or an audio quality metric.

In a second aspect, alone or in combination with the first aspect, the change in the first duration is relative to a reference value of the first duration.

In a third aspect, alone or in combination with one or more of the first and second aspects, the reference value of the first duration comprises an average length of the first duration.

In a fourth aspect, alone or in combination with one or more of the first through third aspects, the first start time is based at least in part on the reference value.

In a fifth aspect, alone or in combination with one or more of the first through fourth aspects, the detection of the change in the first duration comprises a detection of an amount of change that satisfies a change threshold.

In a sixth aspect, alone or in combination with one or more of the first through fifth aspects, the change threshold comprises a percentage change from a reference value, or an absolute time value difference between the first duration and the reference value.

In a seventh aspect, alone or in combination with one or more of the first through sixth aspects, process 600 includes transmitting, before communicating during the time period, an indication of the first start time.

In an eighth aspect, alone or in combination with one or more of the first through seventh aspects, one or more of transmission of the indication of the first start time or transmission of the indication of the second start time comprises one or more of transmitting an indication via an unsolicited target wake time communication, or transmitting the indication via a vendor-specific action frame.

In a ninth aspect, alone or in combination with one or more of the first through eighth aspects, process 600 includes communicating using the second start time based at least in part on receiving an ACK associated with the indication, or retransmitting the indication based at least in part on failing to receive the ACK associated with the indication.

In a tenth aspect, alone or in combination with one or more of the first through ninth aspects, the first start time is based at least in part on a minimum length of the first duration.

In an eleventh aspect, alone or in combination with one or more of the first through tenth aspects, process 600 includes identifying a disconnection of the first wireless connection, and using the second start time until identification of a reconnection of the first wireless connection or a disconnection of the second wireless connection.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

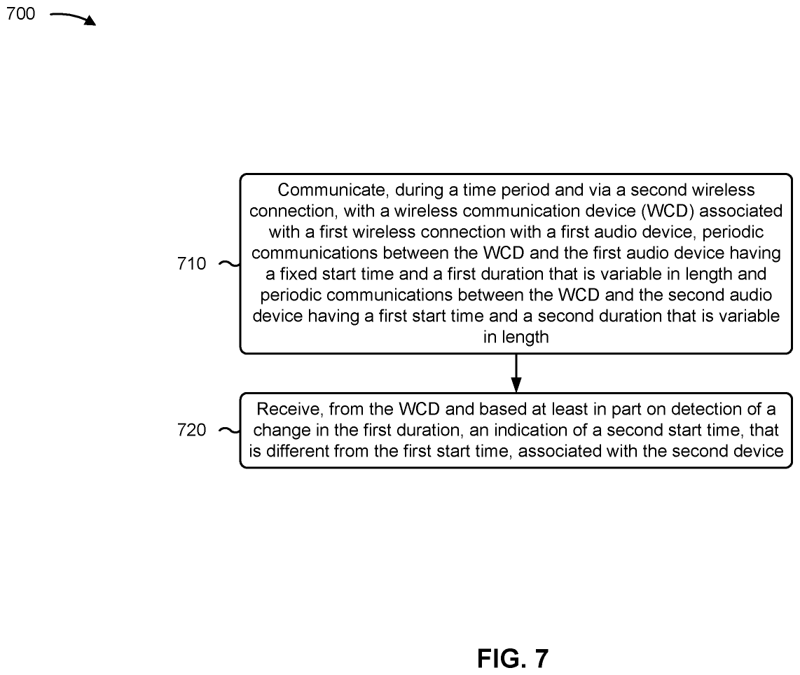

FIG. 7 is a diagram illustrating an example process 700 performed, for example, by a second audio device, in accordance with the present disclosure. Example process 700 is an example where the second audio device (e.g., wireless earbud 130 and/or) performs operations associated with trigger conditions for switching service intervals and service periods.

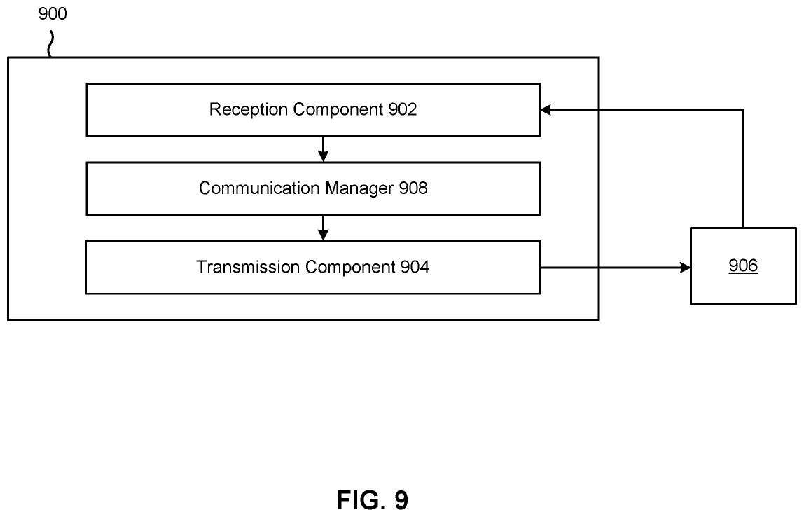

As shown in FIG. 7, in some aspects, process 700 may include communicating, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length (block 710). For example, the second audio device (e.g., using communication manager 908, reception component 902, and/or transmission component 904 depicted in FIG. 9) may communicate, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length, as described above.

As further shown in FIG. 7, in some aspects, process 700 may include receiving, from the WCD and based at least in part on detection of a change in the first duration, an indication of a second start time, that is different from the first start time, associated with the second audio device (block 720). For example, the second audio device (e.g., using reception component 902 depicted in FIG. 9) may receive, from the WCD and based at least in part on detection of a change in the first duration, an indication of a second start time, that is different from the first start time, associated with the second audio device, as described above.

Process 700 may include additional aspects, such as any single aspect or any combination of aspects described below and/or in connection with one or more other processes described elsewhere herein.

In a first aspect, the change in the first duration is based at least in part on one or more changes associated with one or more of a channel condition of the first wireless connection, a MCS, a number of retransmissions, or an audio quality metric.

In a second aspect, alone or in combination with the first aspect, the change in the first duration is relative to a reference value of the first duration.

In a third aspect, alone or in combination with one or more of the first and second aspects, the reference value of the first duration comprises an average length of the first duration.

In a fourth aspect, alone or in combination with one or more of the first through third aspects, the first start time is based at least in part on the reference value.

In a fifth aspect, alone or in combination with one or more of the first through fourth aspects, the detection of the change in the first duration comprises a detection of an amount of change that satisfies a change threshold.

In a sixth aspect, alone or in combination with one or more of the first through fifth aspects, the change threshold comprises a percentage change from a reference value, or an absolute time value difference between the first duration and the reference value.

In a seventh aspect, alone or in combination with one or more of the first through sixth aspects, process 700 includes receiving, before communicating during the time period, an indication of the first start time.

In an eighth aspect, alone or in combination with one or more of the first through seventh aspects, one or more of reception of the indication of the first start time or reception of the indication of the second start time comprises one or more of receiving an indication via an unsolicited target wake time communication, or receiving the indication via a vendor-specific action frame.

In a ninth aspect, alone or in combination with one or more of the first through eighth aspects, process 700 includes communicating using the second start time based at least in part on transmitting an ACK associated with the indication.

In a tenth aspect, alone or in combination with one or more of the first through ninth aspects, the first start time is based at least in part on a minimum length of the first duration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a WCD, or a WCD may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a peripheral device, an earbud, an audio device, and/or another WCD) using the reception component 802 and the transmission component 804. As further shown, the apparatus 800 may include the communication manager 808.

In some aspects, the apparatus 800 may be configured to perform one or more operations described herein. Additionally, or alternatively, the apparatus 800 may be configured to perform one or more processes described herein, such as process 600 of FIG. 6. In some aspects, the apparatus 800 and/or one or more components shown in FIG. 8 may include one or more components of the WCD described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the WCD described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the WCD described in connection with FIG. 2. In some aspects, the transmission component 804 may be co-located with the reception component 802 in a transceiver.

The using communication manager 808, reception component 802, and/or transmission component 804 may communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length. The transmission component 804 may transmit, to the second audio device and based at least in part on detection of a change in the first duration, an indication of a second start time, that is different from the first start time, associated with the second audio device.

The transmission component 804 may transmit, before communicating during the time period, an indication of the first start time.

The using communication manager 808, reception component 802, and/or transmission component 804 may communicate using the second start time based at least in part on receiving an ACK associated with the indication.

The transmission component 804 may retransmit the indication based at least in part on failing to receive the ACK associated with the indication.

The communication manager 808 may identify a disconnection of the first wireless connection.

The using communication manager 808, reception component 802, and/or transmission component 804 may use the second start time until identification of a reconnection of the first wireless connection or a disconnection of the second wireless connection.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a second audio device, or a second audio device may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as another peripheral device, a WCD, and/or another WCD) using the reception component 902 and the transmission component 904. As further shown, the apparatus 900 may include the communication manager 908.

In some aspects, the apparatus 900 may be configured to perform one or more operations described herein. Additionally, or alternatively, the apparatus 900 may be configured to perform one or more processes described herein, such as process 700 of FIG. 7. In some aspects, the apparatus 900 and/or one or more components shown in FIG. 9 may include one or more components of the second audio device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the second audio device described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the second audio device described in connection with FIG. 2. In some aspects, the transmission component 904 may be co-located with the reception component 902 in a transceiver.

The communication manager 908, reception component 902, and/or transmission component 904 may communicate, during a time period and via a second wireless connection, with a WCD associated with a first wireless connection with a first audio device, periodic communications between the WCD and the first audio device having a first start time that is fixed and a first duration that is variable in length and periodic communications between the WCD and the second audio device having a first start time and a second duration that is variable in length. The reception component 902 may receive, from the WCD and based at least in part on detection of a change in the first duration, an indication of a second start time, that is different from the first start time, associated with the second audio device.

The reception component 902 may receive, before communicating during the time period, an indication of the first start time.

The communication manager 908, reception component 902, and/or transmission component 904 may communicate using the second start time based at least in part on transmitting an ACK associated with the indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a wireless communication device (WCD), comprising: communicating, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length; and transmitting, to the second audio device and based at least in part on detection of a change in the first duration, an indication of a second start time, that is different from the first start time, associated with the second audio device.
Aspect 2: The method of Aspect 1, wherein the change in the first duration is based at least in part on one or more changes associated with one or more of: a channel condition of the first wireless connection, a modulation and coding scheme (MCS), a number of retransmissions, or an audio quality metric.
Aspect 3: The method of any of Aspects 1-2, wherein the change in the first duration is relative to a reference value of the first duration.
Aspect 4: The method of Aspect 3, wherein the reference value of the first duration comprises an average length of the first duration.
Aspect 5: The method of any of Aspects 3-4, wherein the first start time is based at least in part on the reference value.
Aspect 6: The method of any of Aspects 1-5, wherein the detection of the change in the first duration comprises: a detection of an amount of change that satisfies a change threshold.
Aspect 7: The method of Aspect 6, wherein the change threshold comprises: a percentage change from a reference value, or an absolute time value difference between the first duration and the reference value.
Aspect 8: The method of any of Aspects 1-7, further comprising: transmitting, before communicating during the time period, an indication of the first start time.
Aspect 9: The method of Aspect 8, wherein one or more of transmission of the indication of the first start time or transmission of the indication of the second start time comprises one or more of: transmitting an indication via an unsolicited target wake time communication, or transmitting the indication via a vendor-specific action frame.
Aspect 10: The method of Aspect 9, further comprising: communicating using the second start time based at least in part on receiving an acknowledgement (ACK) associated with the indication; or retransmitting the indication based at least in part on failing to receive the ACK associated with the indication.
Aspect 11: The method of any of Aspects 1-10, wherein the first start time is based at least in part on a minimum length of the first duration.
Aspect 12: The method of any of Aspects 1-11, further comprising: identifying a disconnection of the first wireless connection; and using the second start time until identification of a reconnection of the first wireless connection or a disconnection of the second wireless connection.
Aspect 13: A method of wireless communication performed by a second audio device, comprising: communicating, during a time period and via a second wireless connection, with a wireless communication device (WCD) associated with a first wireless connection with a first audio device, periodic communications between the WCD and the first audio device having a first start time that is fixed and a first duration that is variable in length and periodic communications between the WCD and the second audio device having a first start time and a second duration that is variable in length; and receiving, from the WCD and based at least in part on detection of a change in the first duration, an indication of a second start time, that is different from the first start time, associated with the second audio device.
Aspect 14: The method of Aspect 13, wherein the change in the first duration is based at least in part on one or more changes associated with one or more of: a channel condition of the first wireless connection, a modulation and coding scheme (MCS), a number of retransmissions, or an audio quality metric.
Aspect 15: The method of any of Aspects 13-14, wherein the change in the first duration is relative to a reference value of the first duration.
Aspect 16: The method of Aspect 15, wherein the reference value of the first duration comprises an average length of the first duration.
Aspect 17: The method of any of Aspects 15-16, wherein the first start time is based at least in part on the reference value.
Aspect 18: The method of any of Aspects 13-17, wherein the detection of the change in the first duration comprises: a detection of an amount of change that satisfies a change threshold.
Aspect 19: The method of Aspect 18, wherein the change threshold comprises: a percentage change from a reference value, or an absolute time value difference between the first duration and the reference value.
Aspect 20: The method of any of Aspects 13-19, further comprising: receiving, before communicating during the time period, an indication of the first start time.
Aspect 21: The method of Aspect 20, wherein one or more of reception of the indication of the first start time or reception of the indication of the second start time comprises one or more of: receiving an indication via an unsolicited target wake time communication, or receiving the indication via a vendor-specific action frame.
Aspect 22: The method of Aspect 21, further comprising: communicating using the second start time based at least in part on transmitting an acknowledgement (ACK) associated with the indication.
Aspect 23: The method of any of Aspects 13-22, wherein the first start time is based at least in part on a minimum length of the first duration.
Aspect 24: An apparatus for wireless communication at a device, comprising a processor; memory coupled with the processor; and instructions stored in the memory and executable by the processor to cause the apparatus to perform the method of one or more of Aspects 1-23.
Aspect 25: A device for wireless communication, comprising a memory and one or more processors coupled to the memory, the one or more processors configured to perform the method of one or more of Aspects 1-23.
Aspect 26: An apparatus for wireless communication, comprising at least one means for performing the method of one or more of Aspects 1-23.
Aspect 27: A non-transitory computer-readable medium storing code for wireless communication, the code comprising instructions executable by a processor to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A wireless communication device (WCD) for wireless communication, comprising:
a memory; and
one or more processors, coupled to the memory, configured to:
communicate, during a time period, with a first audio device via a first wireless connection and with a second audio device via a second wireless connection, periodic communications with the first audio device having a first start time that is fixed and a first duration that is variable in length and periodic communications with the second audio device having a start time and a second duration that is variable in length; and
transmit, to the second audio device and based at least in part on detection of a change in the first duration, an indication of a second start time, that is different from the first start time, associated with the second audio device.

2. The WCD of claim 1, wherein the change in the first duration is based at least in part on one or more changes associated with one or more of:
a channel condition of the first wireless connection,
a modulation and coding scheme (MCS),
a number of retransmissions, or
an audio quality metric.

3. The WCD of claim 1, wherein the change in the first duration is relative to a reference value of the first duration.

4. The WCD of claim 3, wherein the reference value of the first duration comprises an average length of the first duration.

5. The WCD of claim 3, wherein the first start time is based at least in part on the reference value.

6. The WCD of claim 1, wherein the detection of the change in the first duration comprises:
a detection of an amount of change that satisfies a change threshold.

7. The WCD of claim 6, wherein the change threshold comprises:
a percentage change from a reference value, or
an absolute time value difference between the first duration and the reference value.

8. The WCD of claim 1, wherein the one or more processors are further configured to:
transmit, before communicating during the time period, an indication of the first start time.

9. The WCD of claim 8, wherein one or more of transmission of the indication of the first start time or transmission of the indication of the second start time comprises one or more of:
transmit an indication via an unsolicited target wake time communication, or
transmit the indication via a vendor-specific action frame.

10. The WCD of claim 9, wherein the one or more processors are further configured to:
communicate using the second start time based at least in part on receiving an acknowledgement (ACK) associated with the indication; or
retransmit the indication based at least in part on failing to receive the ACK associated with the indication.

11. The WCD of claim 1, wherein the first start time is based at least in part on a minimum length of the first duration.

12. The WCD of claim 1, wherein the one or more processors are further configured to:
identify a disconnection of the first wireless connection; and
use the second start time until identification of a reconnection of the first wireless connection or a disconnection of the second wireless connection.

13. A second audio device for wireless communication, comprising:
a memory; and
one or more processors, coupled to the memory, configured to:
communicate, during a time period and via a second wireless connection, with a wireless communication device (WCD) associated with a first wireless connection with a first audio device, periodic communications between the WCD and the first audio device having a first start time that is fixed and a first duration that is variable in length and periodic communications between the WCD and the second audio device having a first start time and a second duration that is variable in length; and
receive, from the WCD and based at least in part on detection of a change in the first duration, an indication of a second start time, that is different from the first start time, associated with the second audio device.

14. The second audio device of claim 13, wherein the change in the first duration is based at least in part on one or more changes associated with one or more of:
a channel condition of the first wireless connection,
a modulation and coding scheme (MCS),
a number of retransmissions, or
an audio quality metric.

15. The second audio device of claim 13, wherein the change in the first duration is relative to a reference value of the first duration.

16. The second audio device of claim 15, wherein the reference value of the first duration comprises an average length of the first duration.

17. The second audio device of claim 15, wherein the first start time is based at least in part on the reference value.

18. The second audio device of claim 13, wherein the detection of the change in the first duration comprises:
a detection of an amount of change that satisfies a change threshold.

19. The second audio device of claim 18, wherein the change threshold comprises:
a percentage change from a reference value, or
an absolute time value difference between the first duration and the reference value.

20-27. (canceled)

28. A method of wireless communication performed by a second audio device, comprising:
communicating, during a time period and via a second wireless connection, with a wireless communication device (WCD) associated with a first wireless connection with a first audio device, periodic communications between the WCD and the first audio device having a first start time that is fixed and a first duration that is variable in length and periodic communications between the WCD and the second audio device having a first start time and a second duration that is variable in length; and
receiving, from the WCD and based at least in part on detection of a change in the first duration, an indication of a second start time, that is different from the first start time, associated with the second audio device.

29-30. (canceled)
